(19) United States
(12) Patent Application Publication
(10) Pub. No.: US 2023/0394078 A1
(43) Pub. Date: Dec. 7, 2023

(54) SEARCH DEVICE, SEARCH METHOD, AND RECORDING MEDIUM

(71) Applicant: M.D.B Corporation, Tokyo (JP)

(72) Inventors: Yuki ARISATO, Tokyo (JP); Takuya SERA, Tokyo (JP)

(73) Assignee: M.D.B Corporation, Tokyo (JP)

(21) Appl. No.: 18/033,278

(22) PCT Filed: Oct. 29, 2020
(86) PCT No.: PCT/JP2020/040646

§ 371 Date: Apr. 21, 2023

(51) Int. Cl. G06F 16/532; G06F 16/535; G06V 10/40

(52) U.S. Cl. CPC G06F 16/532; G06F 16/535; G06V 10/40

(57) ABSTRACT

In the search device, the feature calculation means calculates an image feature based on an animal image of an animal. The sensitivity feature calculation means calculates a sensitivity feature based on sensitivity information related to preference of a user. The total feature calculation means calculates a total feature based on the image feature of the animal image and the sensitivity feature. The similarity calculation means calculates similarity between the animal image and a target animal image based on the total feature corresponding to the animal image and the total feature corresponding to the target animal image.

### TECHNICAL FIELD

The present disclosure relates to a technique of searching for an animal.

### BACKGROUND ART

Dogs and cats protected by public health centers and public care facilities may be searched for a variety of reasons, such as looking for a foster or a strayed pet dog. As a method of searching for a protected dog, there is known a method of designating attribute information such as the type or gender of the dog to be searched, for example, and searching for a protected dog similar to the dog. However, this method cannot make a search based on information with which attributes are not associated. When detailed attributes related to the appearance are associated, there are such problems that the cost of applying the attributes increases and that a user making search should designate many items of attributes.

Patent Document 1 describes an animal search system for matching animals using a combination of images and attributes.

Incidentally, as a common image search not only for animals, there are known methods for outputting an image similar to an inputted image from search target images by utilizing AI (Artificial Intelligence) or the like.

### PRECEDING TECHNICAL REFERENCES

### Patent Document

Patent Document 1: Japanese Patent Application Laid-Open under No. 2016-224640

### SUMMARY

### Problem to be Solved by the Invention

The animal search system described in Patent Document 1 simply compares the image of the desired animal and the animal identification information of the animal with the image and the animal identification information of the animals stored in a DB and calculates the similarity of each of the image and the animal identification information to perform matching. However, in order to perform matching, it is preferable to enable the search by comprehensively combining various requirements.

One object of the present disclosure is to enable an animal search by appropriately combining various requirements.

### Means for Solving the Problem

In order to solve the above problem, according to an example aspect of the present invention, there is provided a search device comprising:
an image feature calculation means configured to calculate an image feature based on an animal image of an animal;
a sensitivity feature calculation means configured to calculate a sensitivity feature based on sensitivity information related to preference of a user;
a total feature calculation means configured to calculate a total feature based on the image feature of the animal image and the sensitivity feature; and
a similarity calculation means configured to calculate similarity between the animal image and a target animal image based on the total feature corresponding to the animal image and the total feature corresponding to the target animal image.

According to another example aspect of the present invention, there is provided a search method comprising:
calculating an image feature based on an animal image of an animal;
calculating a sensitivity feature based on sensitivity information related to preference of a user;
calculating a total feature based on the image feature of the animal image and the sensitivity feature; and
calculating similarity between the animal image and a target animal image based on the total feature corresponding to the animal image and the total feature corresponding to the target animal image.

According to another example aspect of the present invention, there is provided a A recording medium recording a program, the program causing a computer to:
calculate an image feature based on an animal image of an animal;
calculate a sensitivity feature based on sensitivity information related to preference of a user;
calculate a total feature based on the image feature of the animal image and the sensitivity feature; and
calculate similarity between the animal image and a target animal image based on the total feature corresponding to the animal image and the total feature corresponding to the target animal image.

According to another example aspect of the present invention, there is provided a search device comprising:
an acquisition means configured to acquire an image of an animal to be searched as a target animal image;
an estimation means configured to estimate a similar user who is similar to a user;
a dissimilar image acquisition means configured to acquire an image, which has inputted by the similar user in a past and which is not similar to the image inputted by the user, as a dissimilar image;
an image feature calculation means configured to calculate the image features of the target animal image and the dissimilar image;
a similarity calculation means configured to calculate similarity between the target animal image and the dissimilar image based on the image feature of the target animal image and the image feature of the dissimilar image; and
a result output means configured to output the target animal image whose similarity is larger than a threshold value, as a search result.

According to another example aspect of the present invention, there is provided a search method comprising:
acquiring an image of an animal to be searched as a target animal image;
estimating a similar user who is similar to a user;
acquiring an image, which has inputted by the similar user in a past and which is not similar to the image inputted by the user, as a dissimilar image;
calculating the image features of the target animal image and the dissimilar image;
calculating similarity between the target animal image and the dissimilar image based on the image feature of the target animal image and the image feature of the dissimilar image; and
outputting the target animal image whose similarity is larger than a threshold value, as a search result.

According to another example aspect of the present invention, there is provided a recording medium recording a program, the program causing a computer to:
acquire an image of an animal to be searched as a target animal image;
estimate a similar user who is similar to a user;
acquire an image, which has inputted by the similar user in a past and which is not similar to the image inputted by the user, as a dissimilar image;
calculate the image features of the target animal image and the dissimilar image;
calculate similarity between the target animal image and the dissimilar image based on the image feature of the target animal image and the image feature of the dissimilar image; and
output the target animal image whose similarity is larger than a threshold value, as a search result.

### Effect of the Invention

According to the present disclosure, it becomes possible to search for an animal by appropriately combining various requirements.

### BRIEF DESCRIPTION OF THE DRAWINGS

FIG. 1 is a diagram illustrating a configuration of a search system.

FIG. 2 is a block diagram showing a hardware configuration of a search device.

FIG. 3 is a block diagram showing a functional configuration of the search device of the first example embodiment.

FIG. 4 is a diagram for explaining a technique for calculating an image feature vector.

FIG. 5 is a diagram for explaining a technique for calculating a total feature vector.

FIG. 6 is an example of a search result screen.

FIG. 7 is a flowchart of search processing by the search device of the first example embodiment.

FIG. 8 is an example of a selection screen.

FIG. 9 is a block diagram illustrating a functional configuration of a search device according to a second example embodiment.

FIG. 10 is a diagram for explaining a technique for calculating an attribute feature vector.

FIG. 11 is an example of an input screen.

FIG. 12 is a diagram for explaining a technique for calculating an appearance feature vector.

FIG. 13 is a diagram for explaining a technique for calculating a total feature vector.

FIG. 14 is a flowchart of search processing by the search device of the second example embodiment.

FIG. 15 is a block diagram illustrating a functional configuration of a search device according to a third example embodiment.

FIG. 16 is a flowchart of search processing by the search device of the third example embodiment.

FIG. 17 is a block diagram illustrating a functional configuration of a search device according to a fourth example embodiment.

FIG. 18 is a flowchart of search processing by the search device of the fourth example embodiment.

### EXAMPLE EMBODIMENTS

Preferred example embodiments of the present invention will be described with reference to the accompanying drawings.

### First Example Embodiment

[Overall Configuration]

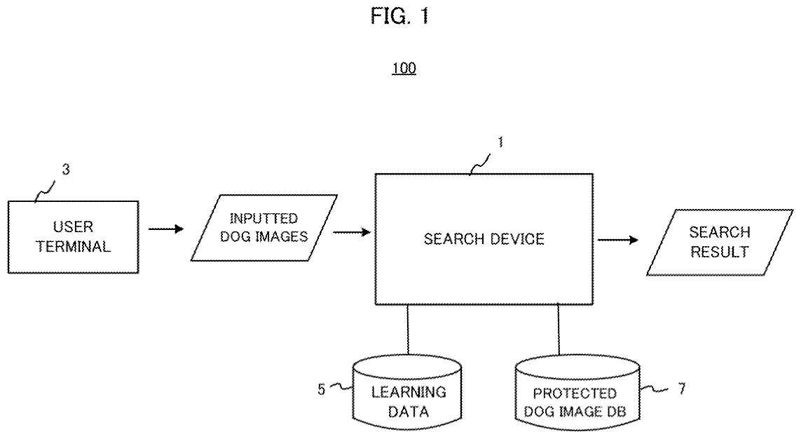

FIG. 1 illustrates a configuration of a search system 100 to which the search device of the present disclosure is applied. The search system 100 is a system for searching for a protected animal similar to a search target animal designated by an image of the animal and sensitivity information of a user inputted by the user, and includes a search device 1 and a user terminal 3.

Here, the animals that can be searched by the search system 100 include, but are not limited to, dogs, cats, rabbits, birds, reptiles such as snakes, and the like. In the this example embodiment, a dog or a cat is mainly used as an animal to be handled by the search system 100.

The search device 1 includes learning data 5 and a protected dog image database (DB) 7. The search device 1 is a device that performs the image search of the protected dogs based on the user input. The user terminal 3 is a variety of terminal devices such as a smart phone, a tablet, a desktop PC, a laptop PC used by the user, and is a terminal to which the user inputs images and attributes of a favorite dog to search for a protected dog.

It should be noted that the protected dogs are dogs that are protected by facilities such as health centers and animal welfare organizations because they were thrown away or lost and their owner does not exist or is unknown, for example. In the present example embodiment, although the protected dogs are searched by the image and the attribute information of the dog for convenience of explanation, it is naturally possible to search the protected cats by the image and the attribute information of the cat.

The user inputs the dog image of the search target dog using the user terminal 3, and transmits the information to the search device 1 through the network. The search device 1 receives the dog image and sensitivity information of the user from the user terminal 3. The search device 1 executes an image search for the protected dog suiting to the user's preference from the protected dog image DB 7 based on the dog image and the sensitivity of the user.

[Hardware Configuration]

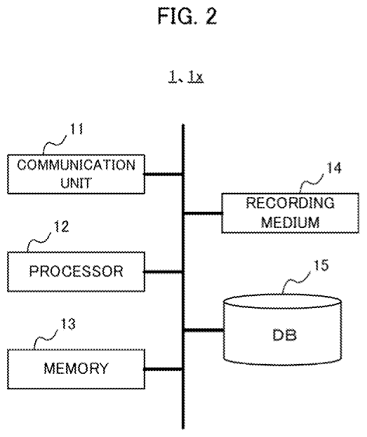

FIG. 2 is a block diagram illustrating a hardware configuration of a search device 1 according to the first example embodiment. As shown, the search device 1 includes a communication unit 11, a processor 12, a memory 13, a recording medium 14, and a database 15.

The communication unit 11 communicates with an external device. Specifically, the communication unit 11 is used to receive the dog image and the attribute information inputted by the user from the user terminal 3 and to transmit the search result to the user terminal 3.

The processor 12 is a computer such as a CPU (Central Processing Unit) and controls the entire search device 1 by executing a program prepared in advance. The processor 12 may be a GPU (Graphics Processing Unit), a FPGA (Field-Programmable Gate Array), a DSP (Demand-Side Platform), an ASIC (Application Specific Integrated Circuit), or the like. The processor 12 executes search processing described later by executing a program prepared in advance.

The memory 13 may include a ROM (Read Only Memory) and a RAM (Random Access Memory). The memory 13 stores various programs executed by the processor 12. The memory 13 is also used as a working memory during various processes performed by the processor 12.

The recording medium 14 is a non-volatile and non-transitory recording medium such as a disk-like recording medium or a semiconductor memory, and is configured to be detachable from the search device 1. The recording medium 14 records various programs executed by the processor 12. When the search device 1 executes the search processing described later, the program recorded in the recording medium 14 is loaded into the memory 13 and executed by the processor 12.

The database 15 stores the learning data 5 used in the learning processing of the model used by the search device 1 and the protected dog image DB 7 including images of a plurality of protected dogs (hereinafter, also referred to as “protected dog images”). The learning data 5 includes dog images and correct answer labels for learning. In addition to the above, the search device 1 may include an input device such as a keyboard and a mouse, and a display device.

[Learning Data]

In the first example embodiment, the dog images for learning are divided into some groups on the basis of the similarity of appearance in advance and the learning data 5 in which the groups are assigned as the correct answer labels are prepared. Also, the learning data 5 is divided into groups based on the similarity of the human preference, and the learning data 5 in which the groups are assigned as the correct answer labels are prepared.

Specifically, the search device 1 acquires information related to the appearance of the dog such as the type, the body type, and the eye color by analyzing the image. Then, the search device divides the dog images for the learning into groups based on the similarity of appearance, and prepare the learning data 5 in which the correct answer labels are assigned. Further, as the grouping based on the human sensitivity, the search device 1 automatically sets the images of the dogs in the same family to the same group as the human preference matches, for example. Also, the search device 1 stores the history of the images inputted by the user in advance, and automatically sets a plurality of dog images inputted by the same user to the same group as the human preference matches, for example. Further, for example, when a “Chihuahua” and a “Shiba dog” are raised in the same household, although the appearance and attribute information of them are not similar, it is guessed that a person who prefers a “Chihuahua” tends to prefer a “Shiba dog” and a “Chihuahua” and a “Shiba dog” are set in the same group. Thus, the search device 1 divides the dog images for the learning into groups based on the similarity of the sensitivity such as the human preference, and prepares the learning data 5 to which the correct answer labels are assigned.

By the way, dogs and cats, especially cats, have a very large variety of appearances, unlike humans. Therefore, if the groups are subdivided to improve the search accuracy, the number of images per group is reduced in the learning data 5.

As a first method for solving such a problem, multiple images of a single dog or a single cat may be used as the learning data 5. For example, several images of a certain dog are prepared and all of them are set to the same group. Further, the learning data 5 may be augmented by mirror image inversion of one predetermined dog image, for example.

As a second method, a single image may be processed to generate multiple images by using a conversion model in which conversion of a color tone or the like is learned or a preset conversion rule, and the generated image may be used as the learning data 5. For example, a conversion model learned to convert the hair color from brown to gray or a preset conversion rule can be used to convert the hair color of a brown tabby cat image to a silver tabby cat image. Similarly, the model may be learned to convert, not only the hair color, but also the eye color or the like. In addition, the conversion model can convert not only the color tone but also the shape, the pattern or the position of the ear. Thus, for example, by performing processing such as color tone conversion and pattern conversion, it is possible to create multiple images from a single cat image, thereby to augment the learning data 5.

[Functional Configuration]

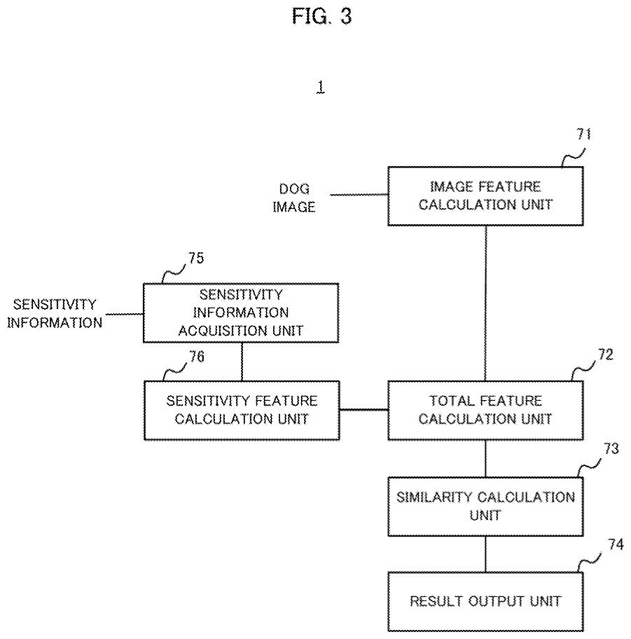

Next, a functional configuration of the search device 1 will be described. FIG. 3 is a block diagram showing a functional configuration of the search device 1. As illustrated, the search device 1 includes an image feature calculation unit 71, a total feature calculation unit 72, a similarity calculation unit 73, a result output unit 74, a sensitivity information acquisition unit 75, and a sensitivity feature calculation unit 76. The image feature calculation unit 71, the total feature calculation unit 72, the similarity calculation unit 73, the result output unit 74, the sensitivity information acquisition unit 75, and the sensitivity feature calculation unit 76 are realized by the processor 12.

The search device 1 calculates the feature vectors from the dog images by using metric learning. The search device 1 calculates the feature vectors so that the feature vectors calculated from similar dog images are located close to each other in the feature vector space and belong to the same group.

The metric learning is a technique by which a model using a neural network is learned so that the distance between two feature vectors reflects the similarity of the images. Specifically, the model is learned so that the distance between the feature vectors obtained from the images belonging to the same group is small and the distance between feature vectors obtained from the images belonging to different groups is large. As the learning of the model advances, the feature vectors calculated from the images with high similarity tend to be dense on the feature space, and the distance between the feature vectors calculated from the images with low similarity tends to be large. The distance here is, for example, digitized by the cosine similarity. As the value is closer to 1, the similarity is higher. While the cosine similarity is used in the present example embodiment, it is merely an example, and Euclidean distance or the like may be used. Using such a learned model, the search device 1 searches the protected dog image DB 7 for a protected dog image similar to the dog image that the user wants to search.

To the image feature calculation unit 71, a dog image is inputted via an image acquisition means not shown. The image acquisition means may be the communication unit 11 described above or an interface used by the user to input an image. The image feature calculation unit 71 calculates the image feature vector corresponding to the inputted dog image by using the image feature extraction model learned by the above-described metric learning.

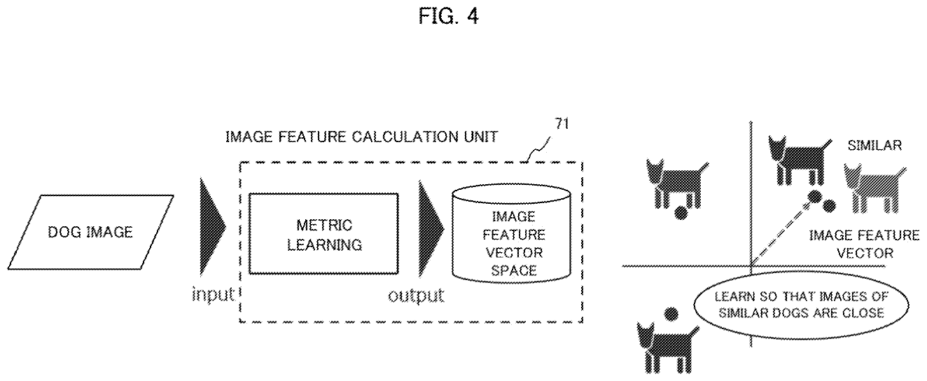

FIG. 4 is a diagram illustrating a technique by which the image feature calculation unit 71 calculates the image feature vector. As shown in FIG. 4, when the dog image is inputted, the image feature calculation unit 71 calculates the image feature vector in the image feature vector space using the image feature extraction model learned by the metric learning. The image feature extraction model clusters the image feature vectors extracted from the inputted images to generate the image feature vector space and calculates the image feature vector in the image feature vector space. Here, the image feature vector space is a space in which the distance between the feature vectors of the dog images with similar appearance becomes close.

The sensitivity information acquisition unit 75 acquires the sensitivity information related to the preference of the user, and outputs it to the sensitivity feature calculation unit 76. The sensitivity feature calculation unit 76 calculates the sensitivity feature vector based on the sensitivity information related to the preference of the user, and outputs it to the total feature calculation unit 72.

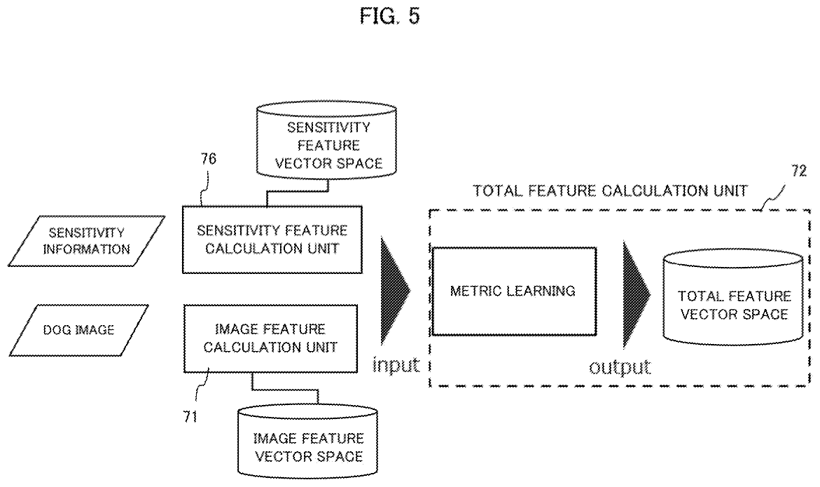

The image feature vector calculated by the image feature calculation unit 71 and the sensitivity feature vector calculated by the sensitivity feature calculation unit 76 are inputted to the total feature calculation unit 72. FIG. 5 is a diagram illustrating a technique by which the total feature calculation unit 72 calculates the total feature vector. As shown in FIG. 5, when the image feature vector and the sensitivity feature vector are inputted, the total feature calculation unit 72 generates a total feature vector space by metric learning and calculates and outputs the total feature vector in the total feature vector space. Here, the total feature vector is a feature vector which is generated on the basis of the sensitivity feature vector related to human sensitivity including the user's preference to the appearance of animals, in addition to the image feature vector. Also, the total feature vector space is such a space that the distance between the feature vectors of the dog images which suit the appearance and the user's sensitivity become close to each other. Thus, by using the total feature vector which is generated based on the user's preference to the animals (e.g., favorite type, personality, fur) in addition to the appearance of the animal based on the image, more appropriate matching of the user and the animals becomes possible.

The similarity calculation unit 73 calculates the similarity of two images in the total feature vector space using the cosine similarity or the like based on the total feature vectors. Specifically, the similarity calculation unit 73 plots the total feature vectors of the dog image of search target inputted by the user and the respective protected dog images stored in the protected dog image DB 7 on the total feature vector space and calculates the similarity based on the distances of the images in the total feature vector space.

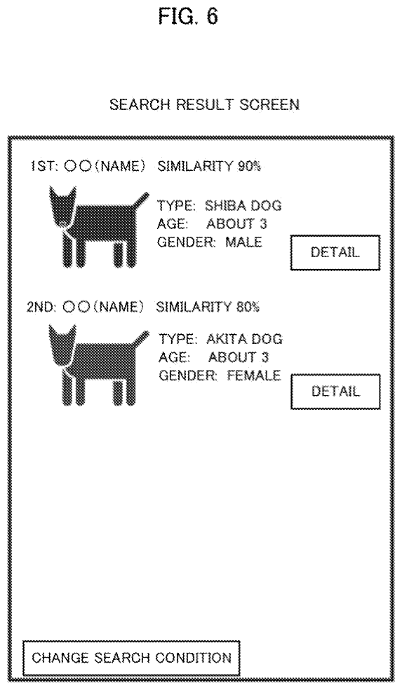

The result output unit 74 outputs the protected dog images as the search result based on the similarity calculated by the similarity calculation unit 73. FIG. 6 is an example of a search result screen. The search result screen is a screen displayed on the user terminal 3, and the protected dog images outputted by the result output unit 74 are displayed as the search result. The display method of the search result is arbitrary. For example, all the protected dog images whose similarity to the dog image of search target inputted by the user is larger than the threshold value may be displayed. Instead, the protected dog images with higher similarity may be displayed in the ranking format. Further, as shown in FIG. 6, the attribute information such as the similarity, name, type, age or gender may be displayed together with the protected dog image. At this time, the result output unit 74 may display a message indicating that it is a result of considering not only the appearance but also the human sensitivity, such as “You may like this dog.”, together with the protected dog image in the search result screen. The user can return to the input screen by pressing the button for changing the search condition on the search result screen and change the dog image serving as the search condition.

[Search Processing]

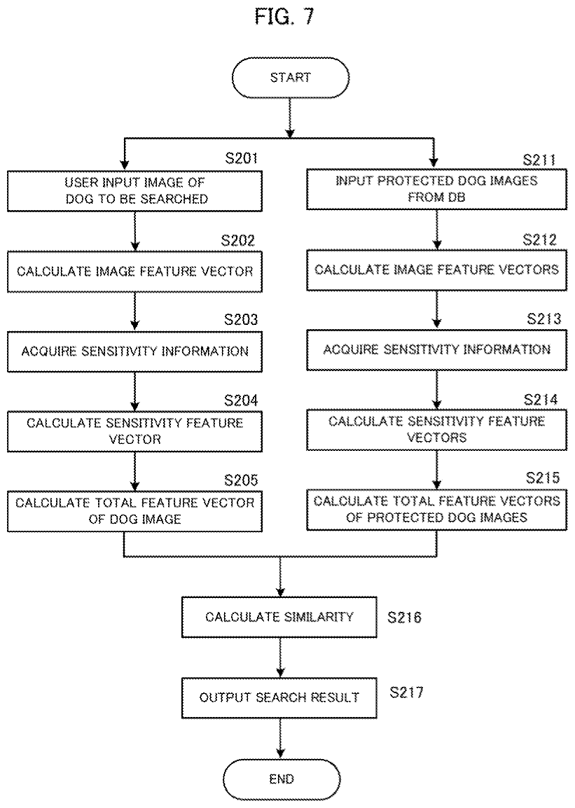

Next, search processing by the search device 1 will be described. FIG. 7 is a flowchart illustrating search processing executed by the search device 1. This processing is realized by the processor 12 shown in FIG. 2, which executes a program prepared in advance.

First, the search device 1 acquires a dog image of a dog to be searched inputted by the user from the user terminal 3. When the dog image to be searched is inputted by the user (step S201), the image feature calculation unit 71 calculates and outputs the image feature vector using the image feature extraction model (step S202). Next, the sensitivity information acquisition unit 75 acquires the sensitivity information (step S203), and the sensitivity feature calculation unit 76 calculates the sensitivity feature vector based on the sensitivity information (step S204). Next, when the image feature vector and the sensitivity feature vector are inputted, the total feature calculation unit 72 calculates and outputs the total feature vector (step S205). Thus, the total feature vector corresponding to the dog image that the user wants to search is calculated.

Further, when the dog images stored in the protected dog image DB 7 are inputted (step S211), the image feature calculation unit 71 calculates and outputs the image feature vectors using the image feature extraction model (step S212). Next, the sensitivity information acquisition unit 75 acquires the sensitivity information (step S213), and the sensitivity feature calculation unit 76 calculates the sensitivity feature vectors based on the sensitivity information (step S204). Next, when the image feature vectors and the sensitivity features vector are inputted, the total feature calculation unit 72 calculates and outputs the total feature vectors (step S215). Thus, the total feature vectors corresponding to all the protected dog images stored in the protected dog image DB 7 are calculated.

In the above description, although the process of steps S201 to S205 and the process of steps S211 and S215 are performed in parallel, it is not necessary to execute them in parallel. For example, the process of steps S211 to S215 may be executed after the process of steps S201 to S205, or vice versa.

Further, the similarity calculation unit 73 calculates the similarity between the dog image to be searched by the user and each protected dog image using the cosine similarity or the like based on the total feature vectors (step S216). Then, the result output unit 74 outputs the protected dog image whose similarity to the dog image to be searched by the user is larger than the threshold as the search result based on the similarity calculated by the similarity calculation unit 73 (step S217). Specifically, as shown in FIG. 6, the result output unit 74 displays the images of the outputted protected dogs on the search result screen together with the attribute information. Thus, by monitoring the search result screen displayed on the user terminal 3, the user can confirm the protected dogs which are similar to the dog to be searched in appearance or the protected dogs which are not similar in appearance but which suit to the sensitivity of the user.

[Effect of the First Example Embodiment]

According to the first example embodiment, an image search can be performed in consideration of not only the appearance but also the human sensitivity. Therefore, a search result that matches the user's preference can be provided even if the user does not intend. That is, it is possible to present the protected dog image that suits the user's preference as the search result, even if the image of the dog is not similar to the dog image that the user wants to search in appearance.

### MODIFIED EXAMPLES

Next, description will be given of modified examples of the first example embodiment. The following modified examples can be applied to the first example embodiment in appropriate combination.

### First Modified Example

In the first example embodiment, the total feature vector is calculated by generating a new total feature vector space by metric learning. However, the present disclosure is not limited to this, and the feature of the image inputted by other users whose preference is similar to the user's preference may be used without generating a new vector space.

Specifically, when the user A inputs a dog image A that he or she wants to search, the search device 1 estimates a similar user who has the preference similar to the user A. As the estimation methods of the similar user, there are a method of estimating a group of users who have inputted the image similar to the input image of the user A as the similar users, and a method of estimating a group of users who have the profile information similar to the profile information of the user A as the similar users. In other words, the search device 1 can cluster the users based on the history of images inputted in the past and the user's profile information, and estimate the group of users having the preference similar to the user A's preference as the similar users.

The search device 1 acquires one or more dog images B that are not similar to the dog image A from the dog images previously inputted by the user B, who is estimated to be the similar user. Then, the search device 1 calculates the image feature vectors for both the dog image A and the dog image B. Further, the search device 1 calculates the similarity based on the image feature vectors of the dog image A and B and the image feature vectors of the protected dogs, and outputs the protected dog image similar to each of the dog images A and B as the search result. The search device 1 displays the protected dog image similar to the dog image A and the protected dog image similar to the dog image B on the search result screen, respectively. At that time, the search device 1 may display a message indicating that is the result is obtained by considering not only the appearance but also the human sensitivity, such as “A person similar to you also likes this dog.” together with the protected dog image similar to the dog image B.

According to this, for example, when the user A inputs the image of “Chihuahua” as a dog image to be searched, the search device 1 first estimates a similar user B having similar preference to the user A. Then, if the similar user B inputted “Shiba dog” other than “Chihuahua” as a dog image to be searched in the past, the search device 1 outputs the protected dog image similar to the image of “Chihuahua” inputted by user A and the protected dog image similar to the image of “Shiba dog” inputted by the similar user B in the past as the search result. In this case, the processor 12 shown in FIG. 2 serves as the acquisition means, the estimation means, the dissimilar image acquisition means, the image feature calculation means, the similarity calculation means and the result output means.

### Second Modified Example

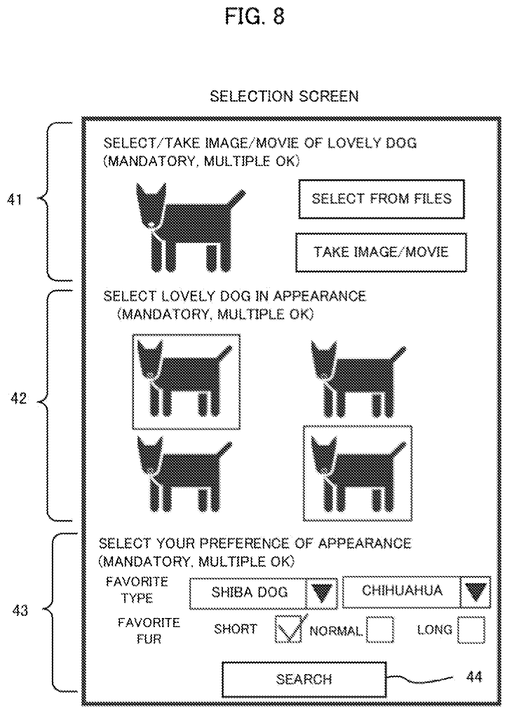

In the first example embodiment, the sensitivity feature vector is calculated using the sensitivity information inputted by the user. FIG. 8 is an example of a selection screen for the user to input the sensitivity information. The selection screen is a screen displayed on the user terminal 3, and the data entered or selected in the selection screen is transmitted to the search device 1. The selection screen includes an item 41 for inputting an image of a dog that the user thinks lovely by selecting a file or taking an image, an item 42 for selecting a dog image that the user thinks lovely in appearance from among a plurality of dog images, an item 43 for selecting user's preference concerning the appearance such as a favorite type and fur, and a search button 44. When the user makes an input or selection and presses the search button 44, the user terminal 3 transmits these data to the search device 1 as the sensitivity information. The search device 1 may calculate the sensitivity feature vector based on the sensitivity information of the user thus acquired. This modified example enables more appropriate matching because users' preferences, which are difficult to be verbalized, can be properly considered.

In the case of the description of FIG. 8, the sensitivity information acquisition unit 75 acquires an animal image that matches the user's preference from the user, as the sensitivity information, from among a plurality of animal images. The sensitivity feature calculation unit 76 calculates the sensitivity feature vector based on the acquired animal image. The total feature calculation unit 72 generates the total feature based on the image feature vector corresponding to the animal, the attribute feature vector, and the sensitivity feature vector. The similarity calculation unit 73 calculates the similarity with the target animal based on the total feature. Thus, it is possible to perform matching in consideration of the sensitivity information related to the user's preference.

### Third Modified Example

Images of dogs and cats may be taken at various magnifications and angles. Therefore, the image feature for the same individual may change according to the difference of appearance. In this view, even for a plurality of images or moving images taken by different image-taking methods, the search device 1 may correct the magnification and/or angle of each inputted image to finally output truly-similar images as the search result. Thus, the accuracy in the image search can be stabilized.

The above search system 100 may be applied to the search for the protected dogs that are similar in appearance to a favorite dog image such as a beloved dog in the past, the search for the protected dogs that are not similar in appearance to a favorite dog image but match the user's preference, and the search for the lost beloved dog.

### Fourth Modified Example

Although the first example embodiment and the first to third modified examples are directed to the search for dogs or cats, it should be understood that this disclosure is not limited thereto and may be directed to any pets such as a rabbit or a hamster. In addition, although the search target is a protected dog or a protected cat in the first example embodiment, the present disclosure is not limited thereto, and the search target can be any pet animal regardless of whether or not it is protected. Further, an image other than the animal, e.g., an image such as other living things, objects, scenery, and the like, may be inputted as an input image to search for an animal similar to the image. By this, it becomes possible to search for an animal similar to the face of the user or other person by inputting a face image of the user or other person, or to search an animal similar to a soccer ball by inputting an image of a soccer ball, for example.

### Fifth Modified Example

In the first example embodiment and the first to fourth modified examples, the feature vector obtained by vectorizing the feature by metric learning is used. However, the present invention is not limited thereto, and the feature of the scalar quantity, not vectorized, may be applied.

### Second Example Embodiment

Next, a second example embodiment of the present disclosure will be described. Since the overall configuration and the hardware configuration of the search device 1x according to the second example embodiment are the same as those of the first example embodiment, the description thereof will be omitted. In the second example embodiment, attribute information is inputted to the search device 1 in addition to the dog image and the sensitivity information.

[Functional Configuration]

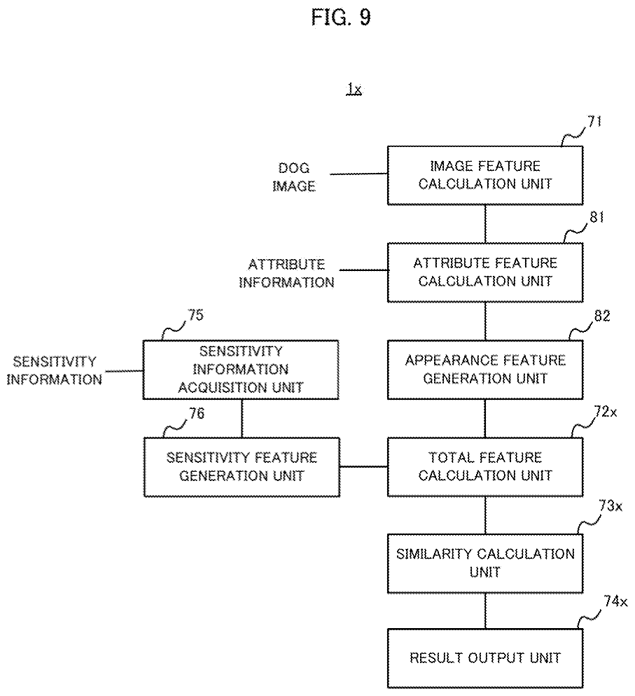

FIG. 9 is a block diagram showing a functional configuration of the search device 1x. The search device 1x is realized by the hardware configuration shown in FIG. 2.

The search device 1x includes an image feature calculation unit 71, an attribute feature calculation unit 81, an appearance feature generation unit 82, a total feature calculation unit 72x, a similarity calculation unit 73x, a result output unit 74x, a sensitivity information acquisition unit 75, and a sensitivity feature calculation unit 76. Since the image feature calculation unit 71 is the same as that in the first example embodiment, the description thereof will not be repeated.

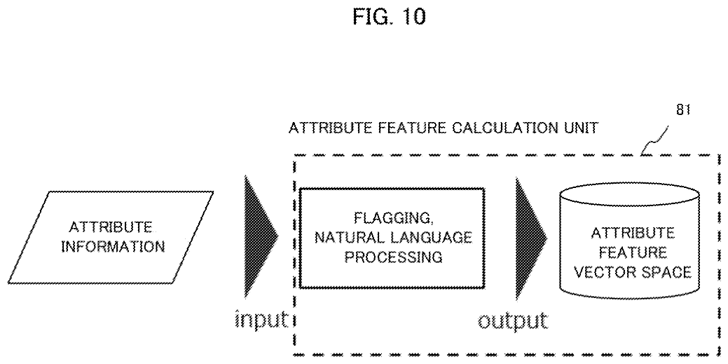

The attribute information of the dog corresponding to the dog image inputted to the image feature calculation unit 71 is inputted to the attribute feature calculation unit 81 through the attribute information acquisition means not shown. The attribute acquisition means may be the communication unit 11 described above or the interface for the user to input the image, for example. Here, the attribute feature is not an image feature but a non-image feature calculated based on the inputted attribute information. FIG. 10 is a diagram illustrating a technique by which the attribute feature calculation unit 81 calculates the attribute feature vector. As shown in FIG. 10, when the attribute information of the corresponding dog is inputted, the attribute feature calculation unit 81 calculates and outputs the attribute feature vector in the attribute feature vector space by flagging or natural language processing. Here, the attribute feature vector is a feature vector in which accuracy related to the appearance is improved and attribute information other than the appearance is also considered. The attribute feature vector space is a space in which the distance between the feature vectors of the dog images which are similar not only in appearance but also in attribute information other than appearance becomes close.

In the second example embodiment, the search device 1x divides the dog images for learning into some groups on the basis of the similarity of appearance in advance and prepares the learning data 5 in which the groups are assigned as the correct answer labels. In this example embodiment, the search device 1x may analyze the images and automatically set the groups based on each item of the attribute information when the attribute information such as the type, body type, and color of the eyes is associated with the image. For example, when the items of the attribute information include the type and the body type, the search device 1x automatically sets the dog images having the same type and the same body type to the same group. Further, the search device 1 may analyze the images and automatically set the groups by clustering using the items of the attribute information as the explanatory variables.

One effect of utilizing the attribute information in addition to the images is to improve the accuracy for the appearance. It is difficult to consider the size of dogs and cats only from the images, and there are cases in which the tail or the like are not captured in the image. In this respect, it is possible to improve the accuracy for the appearance by utilizing the attribute information. The second effect is to realize the search in consideration of the attribute information that cannot be recognized from the images, such as the character and an exercise amount of dogs and cats. The search for a protected dog or cat is often made by the user who is considering rearing dogs or cats in the future. In view of the search for actually rearing dogs or cats, only the information of the appearance is incomplete, and information such as personality and an exercise amount which cannot be considered from the images is useful. That is, by utilizing the attribute information in addition to the images, it becomes possible to make a search considering the attribute information which cannot be recognized from the images.

Specifically, the attribute information includes, but is not limited to, a type of animal, a pattern of body hair, a body weight, fur, a fur color, a fur length, an ear shape, an eye color, a tail shape, a body shape, a gender, an exercise amount, a meal quantity, personality, an age, a birthday, and a health status. The types of animal include dogs, cats, rabbits, birds, and reptiles such as snakes, and their types (the type of dog in case of dogs). The personality of the animal may be guessed based on the type, gender, age, or exercise amount of the pet. For example, “A dog is relatively obedient to the owner”, “A cat is capricious”, “A Chihuahua is small but aggressive”, and “The pet is vigorous and active if the exercise amount is large”.

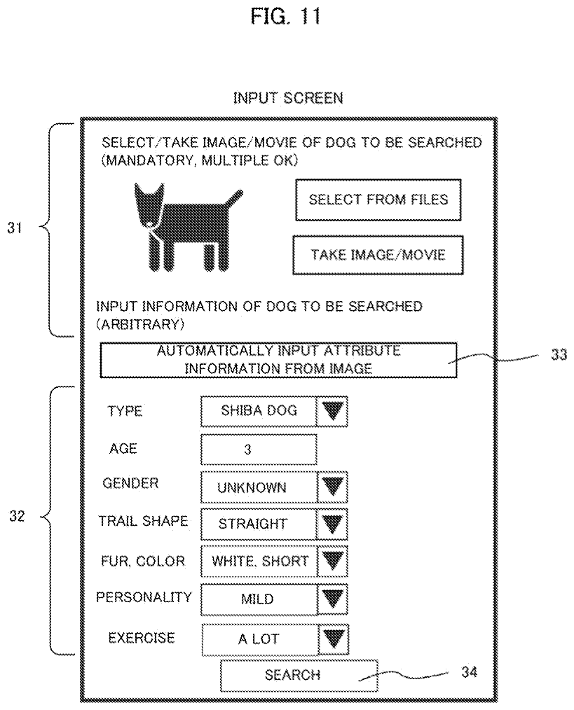

FIG. 11 is an example of an input screen. The input screen is a screen displayed on the user terminal 3, and the data inputted to the input screen is transmitted to the search device 1x. Also, the data transmitted from the search device 1x to the user terminal 3 is reflected on the input screen. The input screen includes an item 31 for inputting a dog image to be searched by selecting a file of an image or a movie or by taking an image or a movie, items 32 for inputting the attribute information such as type, age, and gender, an automatic input button 33, and a search button 34. The user first inputs the desired dog image as the dog image to be searched. The inputted dog image is transmitted to the search device 1x and is inputted to the image feature calculation unit 71.

Then, the user enters the attribute information of the dog to be searched. The input of the attribute information may be performed manually by the user or automatically by the search device 1x based on the dog image. For example, in the case of manual input on the input screen shown in FIG. 8, the user selects an appropriate answer by the pull-down menu at each item 32 of the attribute information such as type and age. On the other hand, when the automatic input button 33 is pressed to perform the automatic operation, the attribute feature calculation unit 81 automatically determines the appropriate answer for each item 32 of the attribute information by analyzing the inputted dog image and displays it on the input screen. If there is an error in the answer to each item 32 automatically determined and displayed, the user may manually correct the error. In addition, the user may manually enter only the attribute information items that cannot be automatically determined from the image, such as personality.

The attribute information inputted to the input screen is transmitted to the search device 1x when the search button 34 is pressed, and is inputted to the attribute feature calculation unit 81. Based on such attribute information, the attribute feature calculation unit 81 calculates and outputs the attribute feature vector in the attribute feature vector space by flagging or natural language processing. Specifically, the attribute feature calculation unit 81 can calculate the attribute feature vector by flagging, e.g., the gender of the attribute information as “male=0, female=1.” Further, the attribute feature calculation unit 81 can calculate the attribute feature vector by automatically taking out a part-of-speech and performing a natural language transformation process from the profile inputted by the protection organizations using AI (e.g., a natural language model generated by an existing technique).

As described above, the attribute feature calculation unit 81 calculates the attribute feature based on the inputted attribute information. However, particularly in the case of a protected dog, all items in the attribute information are not known, and a defect often exists. In that case, missing attribute information must be supplemented. As defect processing to complement the defect, there is a method to infer and complement the missing attribute information such as type, color, and shape of ear from the inputted dog image. In addition, when the missing attribute information cannot be complemented from the inputted dog image, a method of complementing the missing attribute information with statistics such as the average and the most frequent value of other dog images having common or similar attribute information can be used as the defect processing. According to this, the user may enter only the known items when inputting the attribute information. Even if a defect occurs, the attribute feature calculation section 81 can calculate and output the attribute feature by the defect processing without problem.

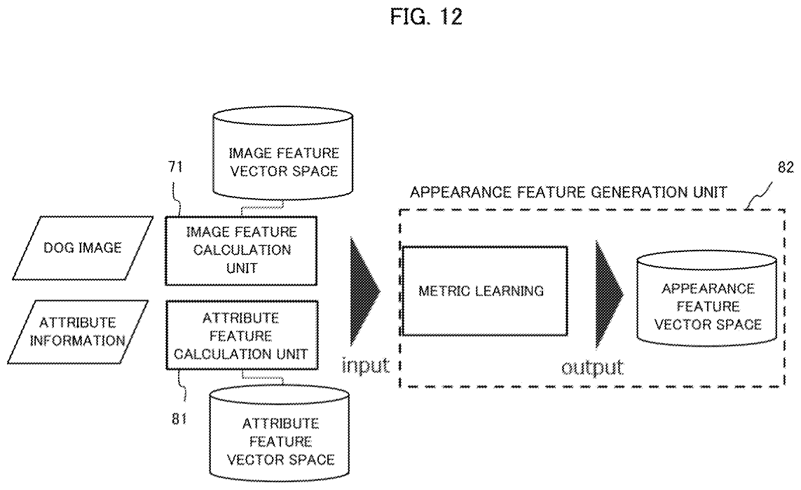

The image feature vector calculated by the image feature calculation unit 71 and the attribute feature vector calculated by the attribute feature calculation unit 81 are inputted to the appearance feature generation unit 82. FIG. 12 is a diagram illustrating a method by which the appearance feature generation unit 82 generates the appearance feature vector. As shown in FIG. 12, when the image feature vector and the attribute feature vector are inputted, the appearance feature generation unit 82 generates and outputs the appearance feature vector in the appearance feature vector space by synthesizing the image feature vector and the attribute feature vector by using metric learning. The scales of the image feature vector and the attribute feature vector may be different, and a simple summation may be impossible. Therefore, a new appearance feature vector space is generated by using the metric learning again, and the appearance feature vector in the new appearance feature vector space is calculated. For example, if the image feature vector is n-dimensional and the attribute feature vector is m-dimensional, the appearance feature vector may be (n+m)-dimensional, or may have any dimension by converting them into a new feature vector. Here, the appearance feature vector is a feature vector in which not only the appearance but also the attribute information other than the appearance are considered. The appearance feature vector space is such a space that the distance between the appearance feature vectors of the dog images in which the appearance and the attribute information other than the appearance are similar is close.

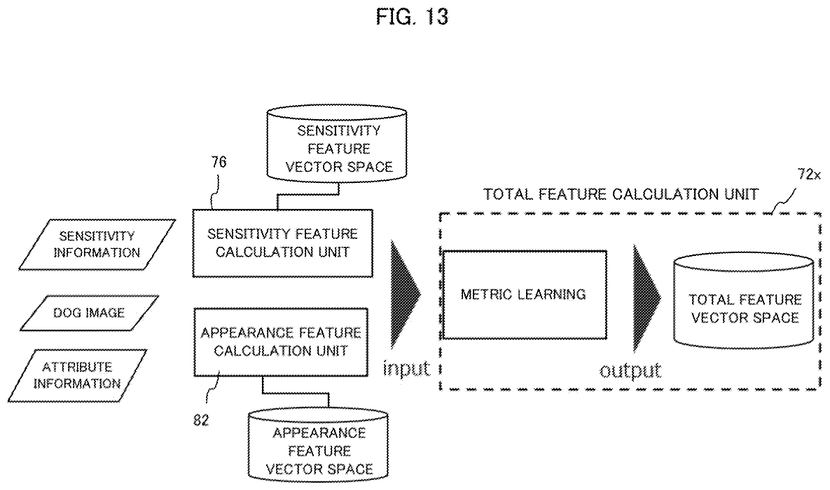

The appearance feature vector calculated by the appearance feature generation unit 82 and the sensitivity feature vector calculated by the sensitivity feature calculation unit 76 are inputted to the total feature calculation unit 72x. FIG. 13 is a diagram illustrating a technique by which the total feature calculation unit 72x calculates the total feature vector. As shown in FIG. 13, when the appearance feature vector and the sensitivity feature vector are inputted, the total feature calculation unit 72x generates a total feature vector space by metric learning and calculates and outputs the total feature vector in the total feature vector space. Here, the total feature vector is a feature vector which is generated on the basis of the sensitivity feature vector related to human sensitivity including the user's preference to the appearance of animals, in addition to the appearance and the attribute information other than the appearance. Also, the total feature vector space is such a space that the distance between the feature vectors of the dog images which suit the user's sensitivity in addition to the appearance and the attribute information other than the appearance becomes close to each other. Thus, by using the total feature vector which is generated based on the user's preference to the animals (e.g., favorite type, personality, fur) in addition to the appearance of the animal based on the image and the attributes of the animal, more appropriate matching of the user and the animals becomes possible.

The similarity calculation unit 73x calculates the similarity of the two images in the total feature vector space using the cosine similarity or the like on the basis of the total feature vectors calculated by the total feature calculation unit 72x. Specifically, the similarity calculation unit 73x plots the total feature vectors of the dog image that the user wants to search and the protected dog images stored in the protected dog image DB 7 on the total feature vector space and calculates the similarity based on the distance between the images in the total feature vector space.

The result output unit 74x outputs the protected dog images as the search result based on the similarity calculated by the similarity calculation unit 74x.

[Search Processing]

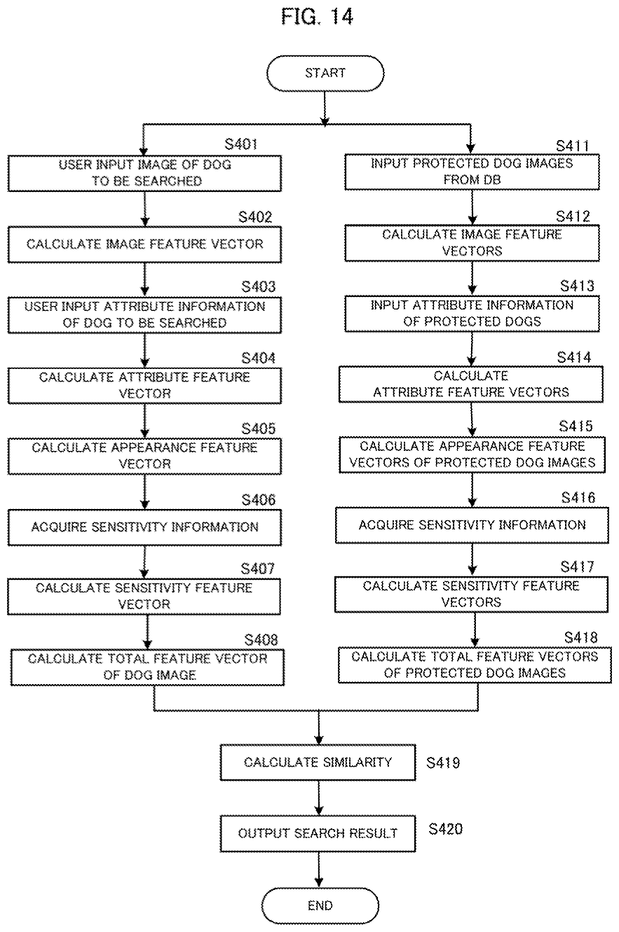

Next, search processing by the search device 1x will be described. FIG. 14 is a flowchart of search processing executed by the search device 1x. This processing is realized by the processor 12 shown in FIG. 2, which executes a program prepared in advance.

First, the search device 1x acquires the image and attribution data of the dog that the user inputs as a dog to be searched, from the user terminal 3. When the dog image to be searched is inputted by the user (step S401), the image feature calculation unit 71 calculates and outputs an image feature vector using the image feature extraction model (step S402). Next, when the attribute information of the dog to be searched is inputted (step S403), the attribute feature calculation unit 81 calculates and outputs the attribute feature vector by flagging or natural language processing (step S404). Further, when the image feature vector and the attribute feature vector corresponding to the dog to be searched are inputted, the appearance feature generation unit 82 calculates and outputs the appearance feature vector (step S405).

Next, the sensitivity information acquisition unit 75 acquires the sensitivity information (step S406), and the sensitivity feature calculation unit 63 calculates the sensitivity feature vector based on the sensitivity information (step S407). Then, when the appearance feature vector and the sensitivity feature vector are inputted, the total feature calculation unit 72x calculates and outputs the total feature vector (step S408). Thus, the total feature vector corresponding to the dog image that the user wants to search is calculated.

Also, when the protected dog images stored in the protected dog image DB 7 are inputted (step S411), the image feature calculation unit 71 calculates the image feature vectors using the image feature extraction model (step S412). Next, when the attribute information of the protected dogs are inputted (step S413), the attribute feature calculation unit 81 calculates and outputs the attribute feature vectors by flagging or natural language processing (step S414). Further, when the image feature vectors and the attribute feature vectors corresponding to the protected dogs are inputted, the appearance feature generation unit 82 calculates and outputs the appearance feature vectors (step S415).

Next, the sensitivity information acquisition unit 75 acquires the sensitivity information (step S416), and the sensitivity feature calculation unit 76 calculates the sensitivity feature vector based on the sensitivity information (step S417). When the appearance feature vectors and the sensitivity feature vector are inputted, the total feature calculation unit 72x calculates and outputs the total feature vectors (step S418). Thus, the total feature vectors corresponding to all the protected dog images stored in the protected dog image DB 7 are calculated.

While the process of steps S401 to S408 is executed in parallel with the process of steps S411 to S418 in the above description, it is not necessarily execute them in parallel. For example, the process of steps S411 to S418 may be executed after the process of steps S401 to S408, or vice versa.

Further, the similarity calculation unit 73x calculates the similarity between the dog image that the user wants to search and the respective protected dog images using the cosine similarity or the like based on the total feature vector corresponding to the dog image that the user wants to search and the total feature vectors corresponding to the protected dog images (step S419). Then, the result output unit 74x outputs the protected dog images having the similarity to the dog image that the user wants to search larger than a threshold, as the search result on the basis of the similarity calculated by the similarity calculation unit 73x (step S420). Specifically, as shown in FIG. 6, the result output unit 74x displays the images of the protected dogs in the search result screen together with the attribute information. Thus, by monitoring the search result screen displayed on the user terminal 3, the user can confirm the image and attribute information of the protected dogs similar to the dog to be searched.

The first to fifth modified examples described in the first example embodiment can be similarly applied to the second example embodiment.

[Effect of the Second Example Embodiment]

According to the second example embodiment, it is possible to search for the protected dogs similar to a favorite dog or a loved dog of the past with high accuracy by using the image and the attribute information of the dog that the user wants to search. In other words, since it is possible to improve the accuracy in view of appearance and perform the search in consideration of the attribute information other than appearance, the search result that matches the user's preference can be presented.

### Third Example Embodiment

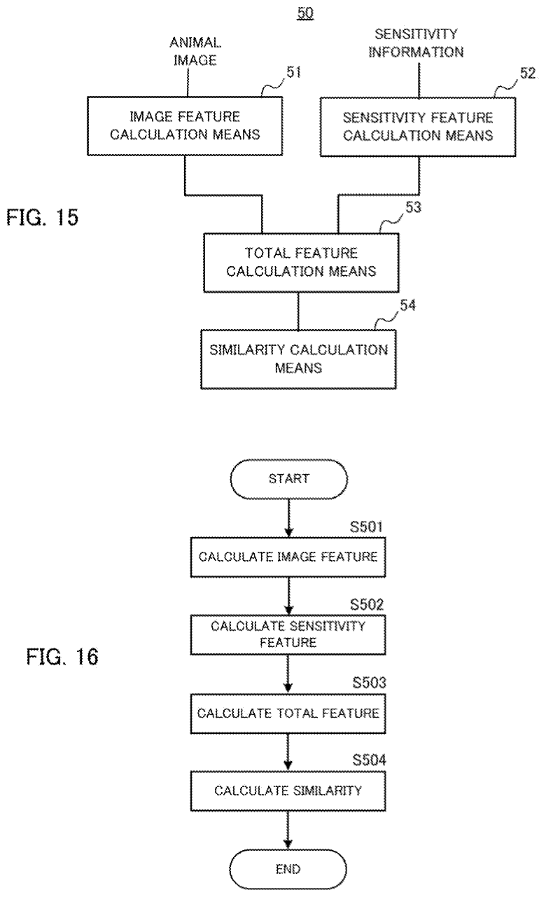

FIG. 15 is a block diagram showing a functional configuration of a search device of a third example embodiment. The search device 50 of the third example embodiment includes an image feature calculation means 51, a sensitivity feature calculation means 52, a total feature calculation means 53, and a similarity calculation means 54. The image feature calculation means 51 calculates an image feature based on an animal image of an animal. The sensitivity feature calculation means 52 calculates a sensitivity feature based on sensitivity information related to preference of a user. The total feature calculation means 53 calculates a total feature based on the image feature of the animal image and the sensitivity feature. The similarity calculation means 54 calculates similarity between the animal image and a target animal image based on the total feature corresponding to the animal image and the total feature corresponding to the target animal image.

FIG. 16 is a flowchart of search processing by the search device of the third example embodiment. The image feature calculation means 51 calculates an image feature based on an animal image of an animal (step S501). The sensitivity feature calculation means 52 calculates a sensitivity feature based on sensitivity information related to preference of a user (step S502). The total feature calculation means 53 calculates a total feature based on the image feature of the animal image and the sensitivity feature (step S503). The similarity calculation means 54 calculates similarity between the animal image and a target animal image based on the total feature corresponding to the animal image and the total feature corresponding to the target animal image (step S504).

According to the search device of the third example embodiment, it is possible to make a search suiting to the sensitivity of the user who has inputted the animal image based on the animal image, based on the animal image.

### Fourth Example Embodiment

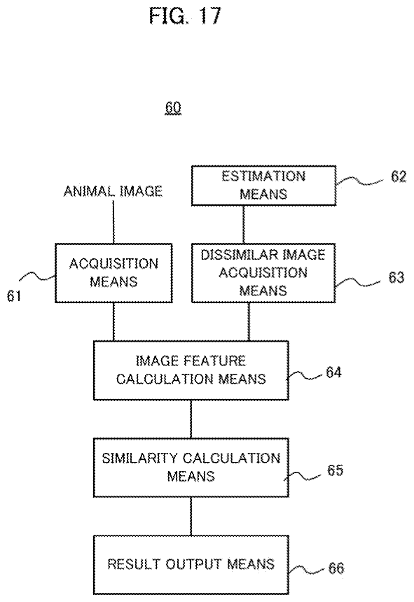

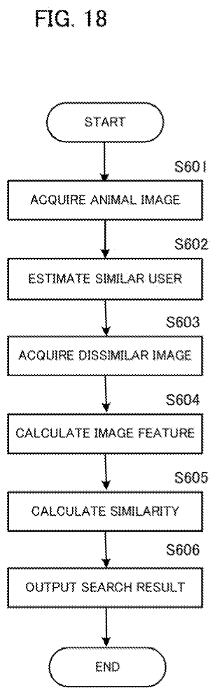

FIG. 17 is a block diagram showing a functional configuration of a search device of a fourth example embodiment. The search device 60 of the fourth example embodiment includes an acquisition means 61, an estimation means 62, a dissimilar image acquisition means 63, an image feature calculation means 64, a similarity calculation means 65, and a result output means 66. The acquisition means 61 acquires an image of an animal to be searched as a target animal image. The estimation means 62 estimates a similar user who is similar to a user. The dissimilar image acquisition means 63 acquires an image, which has inputted by the similar user in a past and which is not similar to the image inputted by the user, as a dissimilar image. The image feature calculation means 64 calculates the image features of the target animal image and the dissimilar image. The similarity calculation means 65 calculates similarity between the target animal image and the dissimilar image based on the image feature of the target animal image and the image feature of the dissimilar image. The result output means 66 outputs the target animal image whose similarity is larger than a threshold value, as a search result.

FIG. 16 is a flowchart of search processing by the search device of the third example embodiment. The acquisition means 61 acquires an image of an animal to be searched as a target animal image (step S601). The estimation means 62 estimates a similar user who is similar to a user (step S602). The dissimilar image acquisition means 63 acquires an image, which has inputted by the similar user in a past and which is not similar to the image inputted by the user, as a dissimilar image (step S603). The image feature calculation means 64 calculates the image features of the target animal image and the dissimilar image (step S604). The similarity calculation means 65 calculates similarity between the target animal image and the dissimilar image based on the image feature of the target animal image and the image feature of the dissimilar image (step S605). The result output means 66 outputs the target animal image whose similarity is larger than a threshold value, as a search result (step S606).

According to the search device of the fourth example embodiment, it is possible calculate, based on the animal image, a total feature in consideration of the sensitivity of the user who has inputted the animal image.

A part or all of the example embodiments described above may also be described as the following supplementary notes, but not limited thereto.

(Supplementary Note 1)

A search device comprising:
an image feature calculation means configured to calculate an image feature based on an animal image of an animal;
a sensitivity feature calculation means configured to calculate a sensitivity feature based on sensitivity information related to preference of a user;
a total feature calculation means configured to calculate a total feature based on the image feature of the animal image and the sensitivity feature; and
a similarity calculation means configured to calculate similarity between the animal image and a target animal image based on the total feature corresponding to the animal image and the total feature corresponding to the target animal image.

(Supplementary Note 2)

The search device according to Supplementary note 1, further comprising a result output means configured to output the target animal image based on the similarity.

(Supplementary Note 3)

The search device according to Supplementary note 1 or 2, further comprising a sensitivity information acquisition means configured to acquire the sensitivity information inputted by the user, wherein the sensitivity feature calculation means calculates the sensitivity feature based on the inputted sensitivity information.

(Supplementary Note 4)

The search device according to any one of Supplementary notes 1 to 3, wherein the sensitivity information includes information indicating preference of the user to the animal, the sensitivity information including at least one of a type, personality and fur that the user likes.

(Supplementary Note 5)

The search device according to any one of Supplementary notes 1 to 4, further comprising:
an attribute feature calculation means configured to calculate an attribute feature based on attribute information of the animal; and
an appearance feature generation means configured to calculate an appearance feature based on the image feature and the attribute feature corresponding to the animal,
wherein the total feature calculation means calculates the total feature based on the appearance feature of the animal image.

(Supplementary Note 6)

The search device according to Supplementary note 5, wherein the attribute information includes at least one of a type of animal, a pattern of body hair, a body weight, fur, a fur color, a fur length, an ear shape, a tail shape, an eye color, a body shape, a gender, an exercise amount, a meal quantity, personality, an age, a birthday, and a health status.

(Supplementary Note 7)

The search device according to Supplementary note 5 or 6, wherein the attribute feature calculation means acquires the attribute information by analyzing the image.

(Supplementary Note 8)

The search device according to any one of Supplementary notes 1 to 7, wherein the image feature calculation means calculates the image feature using a learned model, the learned model being learned using learning data prepared by dividing the animal images into groups based on similarity of the appearance and applying labels.

(Supplementary Note 9)

A search method comprising:
calculating an image feature based on an animal image of an animal;
calculating a sensitivity feature based on sensitivity information related to preference of a user;
calculating a total feature based on the image feature of the animal image and the sensitivity feature; and
calculating similarity between the animal image and a target animal image based on the total feature corresponding to the animal image and the total feature corresponding to the target animal image.

(Supplementary Note 10)

A recording medium recording a program, the program causing a computer to:
calculate an image feature based on an animal image of an animal;
calculate a sensitivity feature based on sensitivity information related to preference of a user;
calculate a total feature based on the image feature of the animal image and the sensitivity feature; and
calculate similarity between the animal image and a target animal image based on the total feature corresponding to the animal image and the total feature corresponding to the target animal image.

(Supplementary Note 11)

A search device comprising:
an acquisition means configured to acquire an image of an animal to be searched as a target animal image;
an estimation means configured to estimate a similar user who is similar to a user;
a dissimilar image acquisition means configured to acquire an image, which has inputted by the similar user in a past and which is not similar to the image inputted by the user, as a dissimilar image;
an image feature calculation means configured to calculate the image features of the target animal image and the dissimilar image;
a similarity calculation means configured to calculate similarity between the target animal image and the dissimilar image based on the image feature of the target animal image and the image feature of the dissimilar image; and
a result output means configured to output the target animal image whose similarity is larger than a threshold value, as a search result.

(Supplementary Note 12)

A search method comprising:
acquiring an image of an animal to be searched as a target animal image;
estimating a similar user who is similar to a user;
acquiring an image, which has inputted by the similar user in a past and which is not similar to the image inputted by the user, as a dissimilar image;
calculating the image features of the target animal image and the dissimilar image;
calculating similarity between the target animal image and the dissimilar image based on the image feature of the target animal image and the image feature of the dissimilar image; and
outputting the target animal image whose similarity is larger than a threshold value, as a search result.

(Supplementary Note 13)

A recording medium recording a program, the program causing a computer to:
acquire an image of an animal to be searched as a target animal image;
estimate a similar user who is similar to a user;
acquire an image, which has inputted by the similar user in a past and which is not similar to the image inputted by the user, as a dissimilar image;
calculate the image features of the target animal image and the dissimilar image;
calculate similarity between the target animal image and the dissimilar image based on the image feature of the target animal image and the image feature of the dissimilar image; and
output the target animal image whose similarity is larger than a threshold value, as a search result.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

1, 1x Search device
3 User terminal
5 Learning data
7 Protected dog image database
11 Communication unit
12 Processor
13 Memory
14 Recording medium
15 Database
71 Image feature calculation unit
72, 72x Attribute feature calculation unit
73, 73x Similarity calculation unit
74, 74x Result output unit
81 Attribute feature calculation unit
82 Appearance feature generation unit

What is claimed is:

1. A search device comprising:
a memory configured to store instructions; and
one or more processors configured to execute the instructions to:
calculate an image feature based on an animal image of an animal;
calculate a sensitivity feature based on sensitivity information related to preference of a user;
calculate a total feature based on the image feature of the animal image and the sensitivity feature; and
calculate similarity between the animal image and a target animal image based on the total feature corresponding to the animal image and the total feature corresponding to the target animal image.

2. The search device according to claim 1, wherein the one or more processors are further configured to output the target animal image based on the similarity.

3. The search device according to claim 1,
wherein the one or more processors are further configured to acquire the sensitivity information inputted by the user, and
wherein the one or more processors calculate the sensitivity feature based on the inputted sensitivity information.

4. The search device according to claim 1, wherein the sensitivity information includes information indicating preference of the user to the animal, the sensitivity information including at least one of a type, personality and fur that the user likes.

5. The search device according to claim 1, wherein the one or more processors are further configured to:
calculate an attribute feature based on attribute information of the animal; and
calculate an appearance feature based on the image feature and the attribute feature corresponding to the animal,
wherein the one or more processors calculate the total feature based on the appearance feature of the animal image.

6. The search device according to claim 5, wherein the attribute information includes at least one of a type of animal, a pattern of body hair, a body weight, fur, a fur color, a fur length, an ear shape, a tail shape, an eye color, a body shape, a gender, an exercise amount, a meal quantity, personality, an age, a birthday, and a health status.

7. The search device according to claim 5, wherein the one or more processors acquire the attribute information by analyzing the image.

8. The search device according to claim 1, wherein the one or more processors calculate the image feature using a learned model, the learned model being learned using learning data prepared by dividing the animal images into groups based on similarity of the appearance and applying labels.

9. A search method comprising:
calculating an image feature based on an animal image of an animal;
calculating a sensitivity feature based on sensitivity information related to preference of a user;
calculating a total feature based on the image feature of the animal image and the sensitivity feature; and
calculating similarity between the animal image and a target animal image based on the total feature corresponding to the animal image and the total feature corresponding to the target animal image.

10. A recording medium recording a program, the program causing a computer to execute the search method according to claim 9.

11. A search device comprising:
a memory configured to store instructions; and
one or more processors configured to execute the instructions to:
acquire an image of an animal to be searched as a target animal image;
estimate a similar user who is similar to a user;
acquire an image, which has inputted by the similar user in a past and which is not similar to the image inputted by the user, as a dissimilar image;
calculate the image features of the target animal image and the dissimilar image;
calculate similarity between the target animal image and the dissimilar image based on the image feature of the target animal image and the image feature of the dissimilar image; and
output the target animal image whose similarity is larger than a threshold value, as a search result.

12.-13. (canceled)
